(19) United States
(12) Patent Application Publication
(10) Pub. No.: US 2025/0327438 A1
(43) Pub. Date: Oct. 23, 2025

(54) PASSIVE TRAILING EDGE INCLUDING LOAD-SHEDDING ASSEMBLY

(71) Applicant: Gulf Wind Technology, Avondale, LA (US)

(72) Inventors: Murray FISHER, Morganton, NC (US); David KING, Avondale, LA (US)

(73) Assignee: Gulf Wind Technology, Avondale, LA (US)

(21) Appl. No.: 19/184,315

(22) Filed: Apr. 21, 2025

Related U.S. Application Data
(60) Provisional application No. 63/637,127, filed on Apr. 22, 2024.

(51) Int. Cl. F03D 1/06

(52) U.S. Cl. CPC F03D 1/0645; F03D 1/069; F05B 2240/304

(57) ABSTRACT

A wind turbine rotor blade that includes a blade body having a shape that generates a lift when impacted by an incident airflow. The blade body includes a pressure side and a suction side shell joining at a leading and a trailing edge, and a load-shedding assembly mechanically coupled with the trailing edge and configured to move from an original position to a reversibly deformed position under an application of an external load, and back to the original position on withdrawal of the external load. The load-shedding assembly includes the pressure and suction side shells, and a number of flexible structural elements mechanically coupled with the shells and configured to cause the load-shedding assembly to move from the original position to the deformed position under the external load and back to the original position on withdrawal of the external load, and thereby, reduce an overall load on the blade body.

### CROSS-REFERENCE TO RELATED APPLICATIONS

This non-provisional patent application claims priority to U.S. provisional patent application No. 63/637,127, filed on Apr. 22, 2024, titled “Passive Trailing Edge Including Load-shedding Assembly”, the contents of which are incorporated herein by reference in their entirety and should be considered part of this specification.

### STATEMENT REGARDING FEDERALLY SPONSORED RESEARCH

This invention was made with government support under Award No. DE-SC0023785 awarded by the Office of Science, United States Department of Energy (DoE). The government has certain rights in the invention.

### BACKGROUND

Wind power is considered one of the cleanest, most environmentally friendly energy sources presently available, and wind turbines have gained increased attention in this regard. As the demand for wind energy continues to grow, there is an increasing emphasis on improving the efficiency of wind energy conversion systems. Wind turbine blades play a crucial role in capturing and converting wind energy into electrical power. Conventional designs, however, are often constrained by the trade-offs between acrodynamic efficiency and structural integrity. Specifically, traditional wind turbine blades face a number of challenges associated with aerodynamic drag, noise generation, and fatigue, which can limit their overall efficiency. In addition, these blades may be slow in their response to severe and unpredictable gust loads causing structural stress and increased fatigue degradation. There remains a need to optimize aerodynamic performance and passive load shedding while protecting and reducing structural stress on wind turbine blades.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1 is an illustrative perspective view of a conventional wind turbine.

FIG. 2 is an illustrative perspective view of a rotor blade of a wind turbine of FIG. 1.

FIG. 3 is an illustrative top view of a rotor blade of a wind turbine of FIG. 1.

FIG. 4 is an illustrative cross-sectional view of a conventional rotor blade of a wind turbine.

FIG. 5 is an illustrative cross-sectional view of a trailing edge load-shedding assembly, in accordance with an embodiment of this disclosure.

FIG. 6 is an illustrative example of design parameters influencing the stiffness of flexible structural elements, in accordance with an embodiment of this disclosure.

FIG. 7 is an illustrative view of a trailing edge load-shedding assembly, in accordance with an embodiment of this disclosure.

FIG. 8 is an illustrative example of design parameters influencing the stiffness of ribbed type or corrugated type flexible structural elements, in accordance with an embodiment of this disclosure.

FIG. 9A is an illustrative graphical view of the effect of flaps on weighted averages of lift polars.

FIG. 9B is an illustrative graphical view of the effect of flaps on weighted averages of drag polars.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

The present disclosure relates to systems and methods of constructing passive trailing edge assemblies of wind turbine blades such that the trailing edge assemblies are enabled with predictable buckling responses under mechanical forces associated with extreme weather conditions. The systems and methods described herein may be designed to enhance the performance and efficiency of wind turbines and further, to optimize acrodynamic performance and passive load-shedding while protecting and reducing structural stress. Specifically, various implementations of the disclosed subject matter relate generally to and may provide improvements in trailing edge assemblies in the way these assemblies respond to clastic buckling (or structural buckling) loads below and beyond critical buckling load yield points.

In recent years, there has been a significant focus on mitigating the adverse effects of aerodynamic drag, noise, and fatigue in wind turbine blades. The trailing edge systems and methods of this disclosure aim to construct solid-state passive trailing edges that structurally resist a linear load until a controlled yield point is reached. At this point, a controlled deflection may occur until the buckling load is reduced back to a sub-deflection level, when the laminates constituting the trailing edges return to their flat baseline shapes. This is achieved by constructing a singular and homogenous composite structure that integrates two or more composite layers having diverse fiber architectures, resin matrices, mixed materials, plastics and the like.

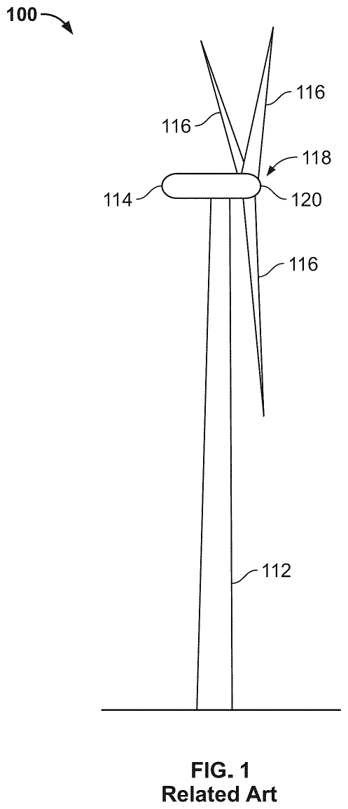

FIG. 1 is an illustrative perspective view of a conventional wind turbine 100. As shown, the wind turbine 100 includes a tower 112 with a nacelle 114 mounted thereon. The wind turbine 100 also includes a rotor hub 118 having a rotatable hub 120 with a plurality of rotor blades 116 mounted thereto, which is in turn is connected to a main flange that turns a main rotor shaft (not shown). The wind turbine power generation and control components are typically housed within the nacelle 114. The view of FIG. 1 is provided for illustrative purposes only to place the present disclosure in an exemplary field of use. It should be appreciated that the disclosure is not limited to any particular type of wind turbine configuration.

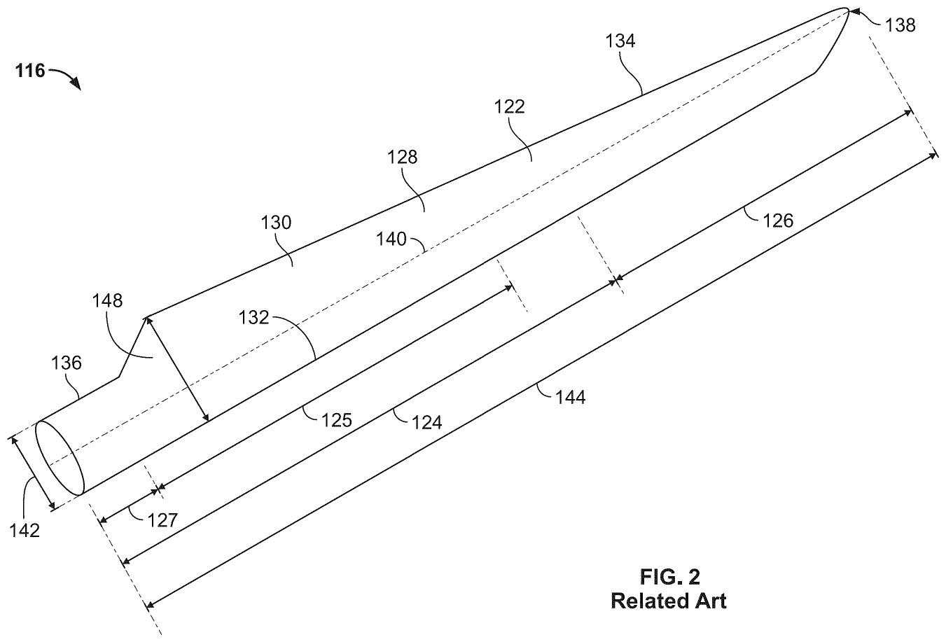

FIG. 2 is an illustrative perspective view of a rotor blade of a wind turbine, such as may be used with the turbine of FIG. 1 or other similar devices and structures. The rotor blade 116 includes one or more features configured to reduce noise associated with high wind speed conditions. As shown, the rotor blade 116 includes an acrodynamic body 122 having an inboard region 124 and an outboard region 126. The inboard and outboard regions 124, 126 define a pressure side 128 and a suction side 130 extending between a leading edge 132 and a trailing edge 134. The inboard region 124 includes a blade root 136, whereas the outboard region 126 includes a blade tip 138.

The rotor blade 116 defines a pitch axis 140 relative to the rotor hub 118 (FIG. 1) that typically extends perpendicularly to the rotor hub 118 and the blade root 136 through the center of the blade root 136. A pitch angle or blade pitch of the rotor blade 116, i.e., an angle that determines a perspective of the rotor blade 116 with respect to the air flow past the wind turbine 100, may be defined by rotation of the rotor blade 116 about the pitch axis 140. In addition, the rotor blade 116 further defines a chord 142 and a span 144. More specifically, as shown in FIG. 2, the chord 142 may vary throughout the span 144 of the rotor blade 116. Thus, a local chord may be defined for the rotor blade 116 at any point on the blade 116 along the span 144.

In certain embodiments, the inboard region 124 may include from about 0% to about 50% of the span 144 of the rotor blade 116 from the blade root 136 in the span-wise direction, whereas the outboard region 126 may include from about 50% to about 100% of the span 144 of the rotor blade 116 from the blade root 136. More specifically, in particular embodiments, the inboard region 124 may range from about 0% span to about 40% of the span 144 of the rotor blade 116 from the blade root 136 in the span-wise direction and the outboard region 126 may range from about 40% span to about 100% span 144 from the blade root 136 of the rotor blade 116. As used herein, terms of degree (such as “about,” “substantially,” etc.) are understood to include a +/−10% variation.

Referring further to FIG. 2, the inboard region 124 may include a transitional region 125 of the rotor blade 116 that includes a maximum chord 148. More specifically, in one embodiment, the transition region 125 may range from about 15% span to about 30% span of the rotor blade 116. In addition, as shown, the rotor blade 116 may also include a blade root region 127 inboard of the maximum chord 148 and within the inboard region 124.

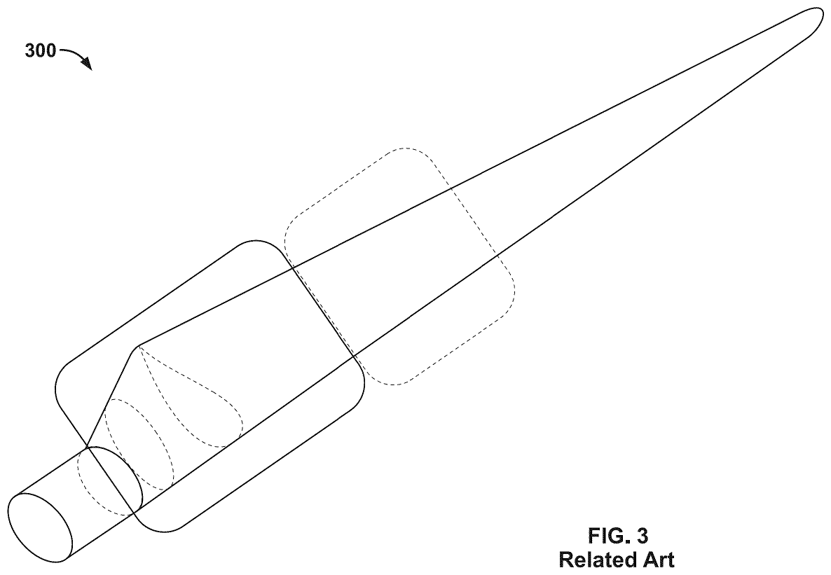

FIG. 3 is an illustrative top view of a rotor blade body 300, such as for use with a wind turbine of FIG. 1 or similar devices and structures. Referring to FIG. 3, for regular (not stalled) flow conditions, the lift and drag forces are functions of the angle of attack of the air relative to the airfoil. The exact dependency of lift and drag forces on angle of attack has to be determined experimentally or by numerical simulation and depends both on the airfoil shape and on the Reynolds number. These relationships are conventionally expressed in terms of the lift and drag coefficients, CL and CD, respectively, defined via with L and D the lift and drag forces, respectively, p the density of the air, S the planform area of the blades, and V the velocity of the air relative to the moving blades.

$$L = \frac{1}{2} ρ {V}_{rel}^{2} {cC}_{L}$$

$${C}_{L} = \frac{L}{\frac{ρ}{2} {SV}^{2}} , {C}_{D} \frac{D}{\frac{ρ}{2} {SV}^{2}} ,$$

Taking the vector product of the force vector F with the radius vector of the turbine arm, one can calculate the torque T that each turbine blade generates. This torque will thus be a function of the wind speed U∞, local tip-speed ratio TSR*, angle of attack of the blade a and of the rotational angle θ, so we have T=T (U∞, TSR*, α, θ). It is important to note that, unless the angle of attack α is chosen judiciously, this torque may be negative (against the direction of rotation of the turbine), and that, for each set of the parameters given above, there is an optimal angle of attack at each position of the blade during its rotation such that the positive (driving) torque is maximized.

For wind turbines and wind turbine blades, the pressure side of the blade is also defined and known as the windward side or the upwind side, whereas the suction side is also defined and known as the leeward side or the downwind side. Typically, the length of the wind turbine blade may be at least 40 meters, or at least 50 meters, or at least 60 meters. The blades may even be at least 70 meters, or at least 80 meters. Blades having a length of at least 90 meters or at least 100 meters are also possible.

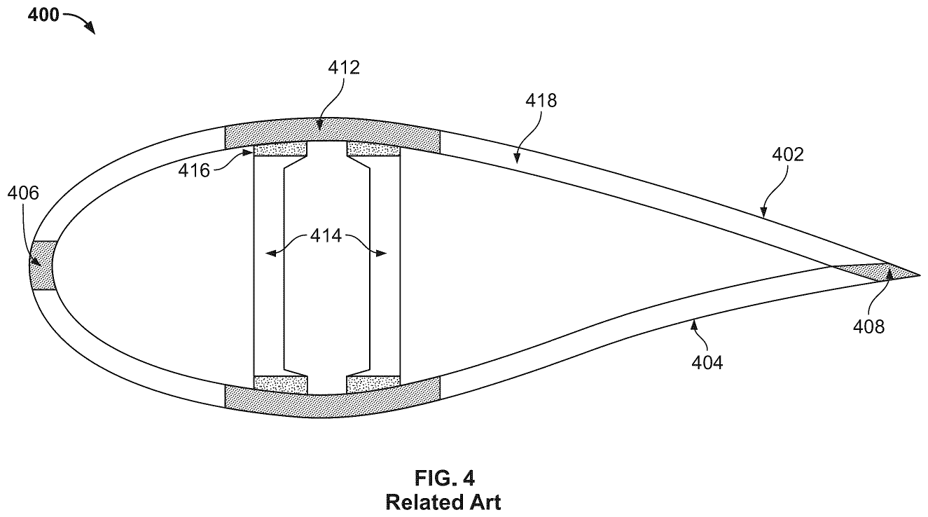

The blade and in particular, the blade body 300 may include a shell structure explained in more detail below, in relation to FIG. 4. The blade body 300 typically includes a longitudinally extending reinforcement section made of fiber layers. The reinforcement section, also called a main laminate, may typically extend from a root region proximate to a rotor hub to a tip region distant from the rotor hub, through a transition region extending between the root region and the tip region.

By recent industry trends, rapid growth and development of wind energy projects into low wind speed geographies indicate a growth in low wind speed markets, internationally. Industry analysis further indicates that the average specific power of wind turbines installed in 2021 has decreased from the 1998-1998 figure of 393 W/m2 to 231 W/m2. Lower specific power ratings for a wind turbine indicate a growth in the rotor diameter/blade length for a given rating. For example, the rotor diameters have increased to 127.5 m in 2021, up 2% from 2020 and 165% from 1998-1999. To capture additional energy from these low wind speed sites, turbines installed in 2021 have hub heights that increased to almost 94 m, up 4% from 2020 and 66% from 1998-1999 levels. The industry analysis is further supported by improved aerodynamic designs, including aerodynamic controls technology.

The expansion of onshore wind turbines into lower wind speed sites and the potential development activities for offshore wind turbines may subject wind turbines with larger rotors and taller hub heights to more extreme wind conditions associated with hurricanes and tropical storms. Further, an analysis of the return period for hurricanes that have passed within 50 nautical miles of various stations along the coastline data indicates that the return periods in several geographies of interest such as the Gulf of Mexico and the Southeast Coastline of the USA may have a return period for Category 1+ hurricanes which is less than one half of the average return period in the hurricane-prone geographies. This suggests that turbine and rotor designs for these sites may need to consider hurricane induced loading during the 20-to-30-year operational lifetime of the wind energy project.

As rotor blade lengths increase, whether as part of the industry growth trends or due to specific designs for low wind sites, the net result is that the variation in flow conditions incident on the blade cross sections increases. This increased variation in wind speed, veer, gusts, and upflow result in increased variation in the acrodynamic loading on the blades. In turn, the increased loading on the blades results directly in increased cost of the blades as additional material is added to ensure strain levels remain within material limits. In addition to the increased blade weight and cost, the turbine cost due to the additional load variation also may increase as this aerodynamic load is passed into the turbine structure and drivetrain, leading to increases in the cost of energy (COE) for wind energy installations.

Wind turbine blades are typically subjected to a series of load cases (or scenarios) in order to define the extreme/ultimate and fatigue loading environment. Several extreme load cases that may prove to be design limiting include design load cases (DLC) for extreme turbulence model, extreme wind shear, extreme operating gust with grid loss (and potentially without grid loss, but this is not an explicit International Electrotechnical Commission or “IEC” load case), extreme wind speeds with significant yaw misalignment, and extreme wind speed with a fault condition (blade failed to pitch).

These load cases tend to be design limiting as the aerodynamic forces on the blade cross sections increase rapidly (28-35% increase in wind speed), with discrete events occurring with a rise time of one to two seconds. Extreme operating gust, for example, may result in a 10 m/s increase in wind speed, which occurs in under two seconds, during the overall 10-second-long event. This rapid change in wind speed may give rise to rapid changes in the local angle of attack, on the order of 10 degrees occurring over 1-2 seconds. This increase in angle of attack may lead to a dramatic increase in lift, up to 80%, and a similar 40% increase in blade root flapwise bending moment. Outside the industry-standard load cases, there may be other examples of events that may occur, particularly during peak wind events such as microbursts or other extreme wind events, where rapid wind speed and direction changes can occur with similar magnitudes and time constants.

There is a perceived need to develop a blade trailing edge (TE) design that can passively reduce peak loads associated with rapid changes in local angle of attack occurring over rise times of two seconds or less.

Traditional approaches to manage blade loading may include hardening the structure to survive the extreme events, sensing and controlling the turbine level response to the event, early-stage research into passive and active aerodynamic control strategies and the like.

Considering an example traditional approach of hardening the blade structure, currently there are not many opportunities to dynamically shed the peak loads during peak load events, and instead, the loads from multiple design load cases collectively form the design envelop for the blade. The structure of the blade, including the spar cap width and thickness as well as amount of structural reinforcement in the shells, most often, may be sized by the limiting envelop. For the spar cap, particularly for carbon spars used today, there is a linear relationship between the applied compressive load and the amount of material needed to ensure that the strain levels remain below allowable limits. Similarly, these extreme loads often lead to panel buckling of the pressure or suction side shells, with a similar relationship between loads and structural reinforcement.

In addition to managing the peak loads with structural reinforcements, modern turbines often use a variety of control mechanisms to manage peak loads. Controllers, in such instances, may be installed to evaluate the measured load indicators and command responses, such as pitching the blades to feather to reduce the angle of attack and thus to reduce the aerodynamic loads. The ability of the turbine to control peak loads with blade pitch activity, may however, be limited by the blade weight, pitch system capacity, and the response time of the turbine. Typical maximum pitch rates for modern wind turbines may be of the order of 1 to 2 degrees per second. The pitch rates, for the control system response alone, may be well below the rate at which the local angle of attach changes (10 degrees over 1-2 seconds). This is further complicated by the response time associated with the development of the load, measurement of the increased load by the turbine, and control decision to initiate a response action. Therefore, approaches that instead focus on the alleviation of the load directly at the blade level are needed.

In addition to turbine controller and structural reinforcement, a third approach to mitigating the peak acrodynamic loads is to incorporate approaches or technology into the blade that directly affect the acrodynamic loading. These approaches include blade level acro-elastic tailoring and/or use of discrete flow control technologies.

Acroclastic tailoring is a “coupled” design approach where the blade planform shape (sweep) or structural fiber layup schedule (off-axis fibers) are tailored to induce a particular response in the blade. Traditionally acroclastic tailoring may be used to induce a twist in the blade cross sections under load, thereby reducing the angle of attack and the forces imparted to the blade. According to industry reports, reductions of up to 6% in COE are possible, with a vision of up to 10% could be achieved by growing the rotor while maintaining the existing load envelope. These studies are typically conducted on shorter, and stiffer blades, for turbines in the 750 kW to 1.5 MW range. Modern blades, however, are much larger and are, relatively, more flexible than their shorter predecessors. Therefore, the blades employed today inherently take advantage of some of the benefits of acroclastic tailoring due to their more compliant structures. Indeed, control schemes to account for and manage this acroclastic twist on modern blades have been developed.

In addition to acro-elastic tailoring, several flow control technologies may be used on wind turbine blades. These flow control technologies may be used to increase or decrease the sectional lift generated on the blade, as described below.

In an instance, large trailing edge (TE) flaps, along with more compact flaps from the rotorcraft industry or piezoelectric actuated flaps may be used on compliant structures actuated via electromechanical means. An active TE flap may be used to reduce loads using a pressure driven active TE system. The reported results for various active TE flaps suggest that the variation in both extreme and fatigue loads may be reduced using actively actuated TE flaps. A disadvantage of these approaches, however, is that they require an active actuation method and they rely on electro/mechanical mechanism for actuating the flap and integration with a control system.

In an instance, small tabs (also known as “microtabs”), on the order of the boundary layer thickness, may be used to reduce the airfoil lift when installed on the airfoil suction surface. These small tabs are electro/mechanically deployed from the surface and they may require integration of hardware to sense and trigger deployment of the tabs. This technology has not been deployed commercially due to the obstacles of integrating the actuator into the blade and the control system of the turbine. Microspoilers may be used for shedding load with leading edges (“LE”), which has indicated significant control authority of the microspoilers on reducing the load associated with extreme shutdown load cases for a downwind rotor. Additionally, the microspoilers may also be used with upwind rotor configurations, where power production load cases produced envelop defining loads. Similar to other approaches with actuated sensors, the details of solving the actuator and control system integration may be critical to the developing of any active flow control system.

In an instance, trailing edge effectors including deployable gurney flaps, located directly on a blunt TE may be used to control loads on trailing edges. However, the approach needs physical integration with the blade and turbine controller. Alternately, similar to TE effectors and microtabs, a microflap may be used to replaces the nominal TE with a flap that is housed in the TE and can rotate +/−90 degrees, acting like a gurney flap to affect lift. This is typically an active device and it requires physical and controller integration.

In an example, stall strips may be actively deployed to fix transition around the leading edge (LE) of the airfoil, reducing the lift generated across the airfoil.

In an instance, high velocity jets may be used to blow air and control circulation of air around a rounded or semi-rounded TE. As with other technologies, they require active control, integration of the pressure tubing, and system integration with the blade and turbine.

In an instance, shape changing airfoils may be used on deformable skin and along with an electro/mechanical means of actuating a deformable member within the airfoil. This deformation then induces a change in the airfoil shape, thus allowing for load control. As with other devices, these require active sensing, actuators and control integration.

In an instance, a Fish Bone Active Camber (or “FishBAC”) TE structure may be used that includes a thin chordwise flexible beam, onto which ribs may be connected between the flexible beam and a pretensioned skin layers. An actuator then controls ‘tendons” attached to the structure that cause the beam to deflect. The control authority of the device may be effective, leading to changes in the lift coefficient of 0.5 to 0.7 for a 20% chord TE. As with other adaptive TE devices, however, it requires both a significant change in the TE architecture as well as an actuator to physically manipulate the tendons to induce the deformation.

In an instance, a selectively compliant TE structure may be used that has shown theoretical promise for of reduction normal forces on the blades by 6 to almost 50% for various TE flap lengths and amounts of deflection. One of the important elements of this approach is the development of an internal rib within the TE with a bi-modal stiffness. As the load on the TE increases, due to a gust, this loading will exceed the capacity of the initial TE structural state, causing it to deform and adopt the second state, leading to a deformation of the TE, and a reduction in the load. The bi-modal stiffness rib, however, requires the use of a corrugated suction surface in order to achieve the required deformation of the airfoil surface. This corrugation directly impacts the aerodynamics, resulting in a loss of airfoil efficiency and reduction in turbine power production during normal operation. In addition, this approach adopted still requires a device to activate to force the bi-modal stiffness rib to return to the nominal, power producing configuration.

In summary, active blade airfoil elements (leading and trailing edge), as described above, influence the loading on a wind turbine airfoil with significant control authority to reduce the peak load. Various kinds of airfoil elements have the potential to influence the blade aerodynamics to reduce loads. Integration and activation of the elements, however, are required to achieve the required effect. For example, the elements discussed above may require a means of sensing the need for deployment, a means of activation, and a mechanism by which this is integrated into a controller. Even the passive approaches discussed may still require the use of a device to return the element to its nominal position after passive deployment. As discussed above, the challenges inherent in developing flow control devices focus on the integration of the acrodynamic feature into the blade structure, providing a means or mechanism to provide the trigger to cause the controller to deploy the feature, and the overall integration of the system with the turbine controller.

Further, there is a potential risk inherent in the use of any active airfoil element is the risk of unwanted acroclastic effects. These effects, such as flutter, occur when the airfoil structure extracts energy from the airflow, resulting in large amplitude oscillations. These oscillations in turn can cause damage to the component. Given the breadth of analytical and testing requirements inherent in addressing this risk, any flutter or unsteady acro-elastic effects may be addressed in subsequent research after the completion of the research elements.

To overcome these challenges, the present systems and methods relate to and describe passive load control techniques. The novel approach to passively deforming TE construction outlined above is that it enables the development of lower cost wind turbine blades and enables these rotors to enter low wind speed sites which are subject to peak extreme loads.

FIG. 4 is an illustrative cross-sectional view of a blade body 400 of a conventional rotor blade of a wind turbine. Referring to FIG. 4, the blade body 400 may be designed in a shape that generates a lift when impacted by an incident airflow. The blade body 400 may include a laminate outer shell (also referred to as “pressure side”) 402 and a laminate inner shell (also referred to as “suction side”) 404 joining at a leading edge 406 and a trailing edge 408. The outer shell 402 and the inner shell 404 may be made of a composite material. The composite material may be a resin matrix reinforced with fibers. In most cases the polymer applied is thermosetting resin, such as polyester, vinylester or epoxy. The resin may also be a thermoplastic, such as nylon, PVC, ABS, polypropylene or polyethylene, or another thermosetting thermoplastic, such as cyclic PBT or PET. The fiber reinforcement is most often based on glass fibers or carbon fibers, but may also be plastic fibers, plant fibers or metal fibers. The composite material may often include a sandwich structure including a core material, such as foamed polymer or balsawood.

Referring back to FIG. 4, the outer shell 402 and the inner shell 404 are internally supported and joined by a supporting and stiffening structure, known as “spar cap”, 412. The spar cap may include a number of supporting and stiffening column-like structures, known as “shear webs”, 414. The spar cap 412 and the shear webs 414 may be internally joined with the inner sides of the outer shell 402 and the inner shell 404 by an adhesive 416. The outer shell 402 and the inner shell 404 may be internally padded with balsa or foam 418, used as shock absorbing elements.

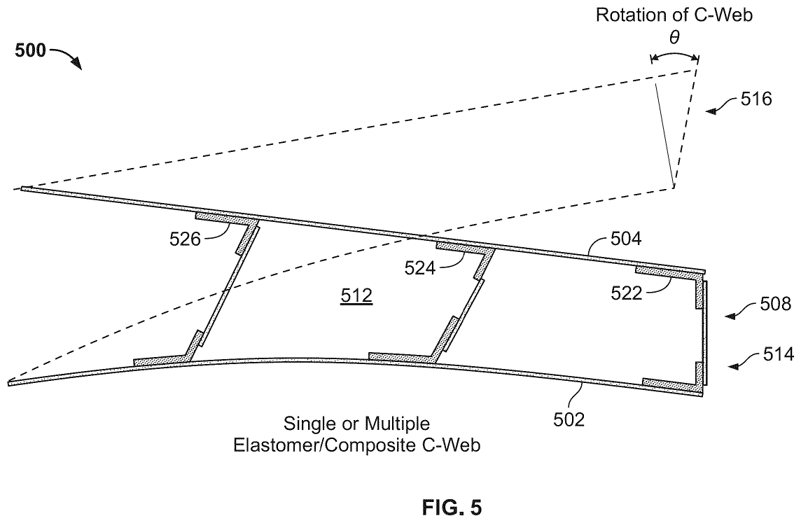

FIG. 5 is an illustrative cross-sectional view of a trailing edge load-shedding assembly, in accordance with an embodiment of this disclosure. Referring to FIG. 5, a blade body 500 of a wind turbine rotor blade is described. The blade body 500 may typically have a shape that generates a lift when impacted by an incident airflow. The blade body 500 includes a pressure side shell 502 and a suction side shell 504 joining at a leading edge (406 of FIG. 4), and a trailing edge (508 and 408 of FIG. 4). The blade body 500 also includes a trailing edge load-shedding assembly 512 mechanically coupled with the trailing edge 508. The trailing edge load-shedding assembly 512 is configured to move from an original nominal position 514 to a reversibly deformed position 518 under an application of an external load (not shown), and move back from the deformed position 516 to the original nominal position 514 on withdrawal of the external load.

The trailing edge load-shedding assembly 512 may include the pressure side shell 502, the suction side shell 504, and a number of flexible structural elements 522, 524, 526 that are housed or placed within and mechanically coupled with the pressure side shell 502 and the suction side shell 506. The flexible structural elements 522, 524, 526 are configured to cause the trailing edge load-shedding assembly 512 to move from the original nominal position 514 to the deformed position 516 under the external load, and to move back from the deformed position 516 to the original nominal position 514 on withdrawal of the external load. The movement of the trailing edge load-shedding assembly 512 from the original nominal position 514 to the deformed position 516, and then back to the original nominal position 514 reduces the overall load on the blade body 500 and enhances the aerodynamic performance of the blade body 500. As is commonly known in the wind turbine blade performance art, this phenomenon is referred to as “load-shedding”.

In an instance, the flexible structural elements 522, 524, 526 may be elastomer or composite C-web type flexible structural elements designed to achieve a target deformation in the aft region of the blade, from 10% to 20% of the airfoil zone, or from 10% to 50% of the airfoil zone as non-limiting examples. The flexible structural elements 522, 524, 526 may be constructed from elastomer or composite materials and designed to allow for flexible deformation of the passive load-shedding trailing edge assembly without causing static or fatigue damage to the trailing edge mechanisms. Further, the internal structural elements 522, 524, 526 may be designed to perform as a series of stiffness elements or springs housed within the trailing edge assembly. In an instance the internal structural elements 522, 524, 526 may be designed to perform as a series of stiffness elements or damped elements housed within the trailing edge assembly. The flexible structural elements 522, 524, 526 may include a first group of end-positioned flexible structural elements 522 that are positioned at the tip or end of the trailing edge 508 and a second group of mid-positioned flexible structural elements 524 that are positioned in the middle or central regions of the trailing edge 508.

The end-positioned flexible structural elements 522 may cause the pressure side shell 502 and the suction side shell 504 to rotate and translate relative to the original nominal position 514 of the trailing edge load-shedding assembly 512 under the external load. As represented in FIG. 5, during deformation of the passive load-shedding trailing edge assembly 512 towards the suction side shell (to shed load) 504, the rotation of the passive load-shedding trailing edge assembly 512 (specifically the pressure side shell and a suction side shell) may cause a translation of the suction side shell 504 relative to the pressure side shell 502. The elastomer or composite C-web flexible structural elements 522 located at the end-position of the trailing edge are designed to allow the translation and rotation of the shells, and may be designed through the choice and layup of the constituent materials to achieve the targeted deformation of the trailing edge.

The mid-positioned flexible structural elements 524, 526 are configured to perform like a series of stiffness elements or spring elements or damped elements under the external load, allow the trailing edge load-shedding assembly 512 to move from the original nominal position 514 to the deformed position 516, beyond a predetermined threshold value of the external load, without causing a static or a fatigue damage to the trailing edge load-shedding assembly 512. In a similar manner, the mid-positioned flexible structural elements 524, 526 are further designed to allow the trailing edge load-shedding assembly 512 to move back from the deformed position 516 to the original nominal position 514, under the predetermined threshold value of the external load, without causing the static or the fatigue damage to the trailing edge load-shedding assembly 512.

To elaborate further, the C-web type mid-positioned flexible structural elements 524, 526 made of elastomer or composite materials, as an example and located at the mid-position of the trailing edge, may be bonded to the pressure side shell 502 and the suction side shell 504, at predetermined positions and angles relative to the trailing edge planes in order to achieve a nominal stiffness of the trailing edge assembly 512. At a point when the stiffness is exceeded by the peak aerodynamic load, the flexible trailing edge assembly 512 may begin to deform from nominal position 514 to the deformed position 516. Later on, by using the elastomer or composite C-web mid-positioned or end-positioned structural elements 524, 526 that act in a “spring-like” or “damped-like” manner, the flexible trailing edge assembly 512 may return to its nominal configuration 514 as the load decreases.

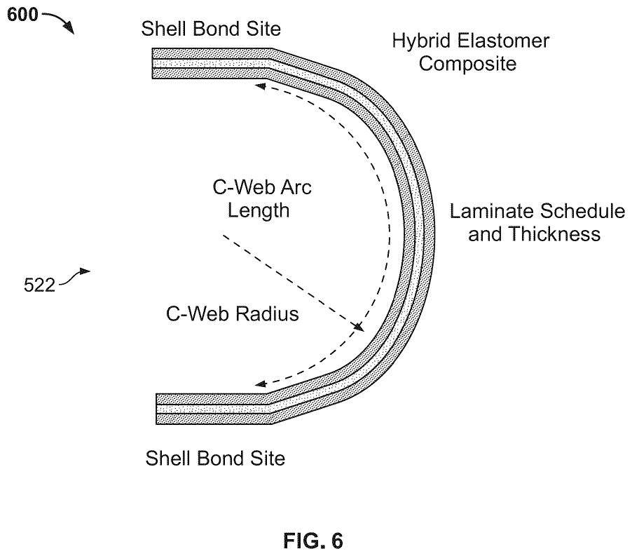

FIG. 6 is an illustrative example of a number of design parameters that may influence the stiffness of C-web type flexible structural elements, in accordance with an embodiment of this disclosure. To allow the deformation and rotation of the pressure side shell 502 and the suction side shell 504, the flexible C-web structural elements are included into the trailing edge assembly 512. The flexible C-web structural elements may be made of a hybrid laminate including of flexible elastomer component layers and stiffer traditional glass laminate layers. In an instance, an analytical model may be used to determine the stiffness of the C-web flexible structural elements, given a set of input parameters. The set of input parameters that may influence the stiffness of the C-web may include thickness, type, taper for elastomer composite materials, material weight, type, thickness, taper for glass composite materials, ply drop locations, and geometrical definition parameters such as initial height, bonded height, arc length, and radius of C-web and the like.

In operation, prototype webs may be fabricated based on the stiffness models for the C-web flexible structural elements and these prototype webs may be subjected to point loads to understand the deflection or stiffness against the model prediction. In an instance, the stiffness models may provide a design for the airfoil with a 20% chord passive load-shedding trailing edge for the 25% lift coefficient reduction, as non-limiting examples.

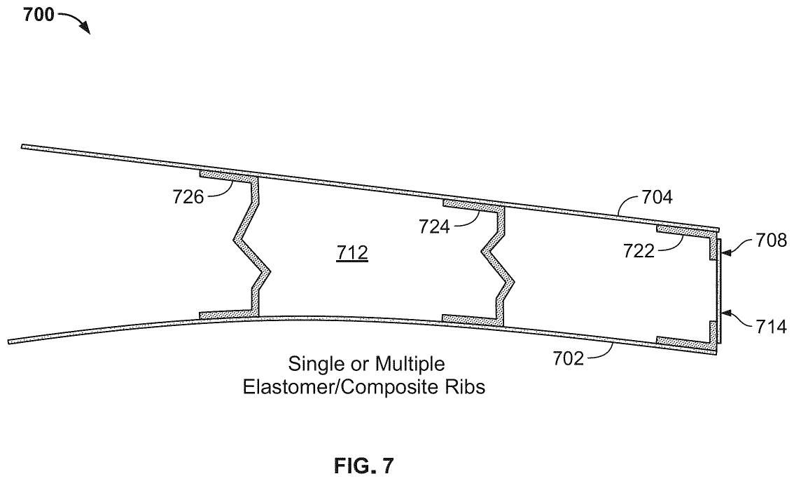

FIG. 7 is an illustrative view of a trailing edge load-shedding assembly including ribbed type (also known as and referred to as “corrugated type”) flexible structural elements, in accordance with an embodiment of this disclosure. Referring to FIG. 7, the blade body 700 may include the parts and components of a conventional rotor blade of a wind turbine, as described in relation to FIG. 5, such as a pressure side shell 702 and a suction side shell 704 joining at a leading edge (406 of FIG. 4), and a trailing edge (708 and 408 of FIG. 4). The blade body 700 may include a trailing edge load-shedding assembly 712 mechanically coupled with the trailing edge 708. The trailing edge load-shedding assembly 712 may be configured to move from an original nominal position 714 to a reversibly deformed position (not shown) under an application of an external load (not shown), and move back from the deformed position to the original nominal position 714 on withdrawal of the external load.

The trailing edge load-shedding assembly 712 may include the pressure side shell 702, the suction side shell 704, and a number of flexible structural elements 722, 724, 726 that are housed within and mechanically coupled with the pressure side shell 702 and the suction side shell 706. The flexible structural elements 722, 724, 726 may be configured to cause the trailing edge load-shedding assembly 712 to move from the original nominal position 714 to the deformed position under the external load, and to move back from the deformed position to the original nominal position 714 on withdrawal of the external load. The movement of the trailing edge load-shedding assembly 712 from the original nominal position 714 to the deformed position, and then back to the original nominal position 714 reduces the overall load on the blade body 500 and enhances the aerodynamic performance of the blade body 700, as is commonly known as “load-shedding”.

In an instance, in addition to the C-web stiffness concept of FIGS. 5 and 6, an alternative geometry for the stiffness element may be used in the passive load-shedding trailing edge assembly. This alternative stiffness element, a rib, may be made of a hybrid laminate that may include flexible elastomer component layers and stiffer traditional glass laminate layers. Referring to FIG. 7, the flexible structural elements 722, 724, 726 may be ribbed type or corrugated type flexible structural elements designed to achieve a target deformation in the aft region of the 10% to 20% of the airfoil zone, as non-limiting examples. The flexible structural elements 722, 724, 726 may be constructed from an elastomer or composite materials and designed to allow for flexible deformation of the passive load-shedding trailing edge assembly without causing static or fatigue damage to the trailing edge 708 or the trailing edge load-shedding assembly 712. Further, the flexible structural elements 722, 724, 726 may include a first group of end-positioned flexible structural elements 722 that are positioned at the tip or end of the trailing edge 708, and a second group of mid-positioned flexible structural elements 724 or 726 that are positioned in the middle or central regions of the trailing edge 708.

The end-positioned flexible structural elements 722 may cause the pressure side shell 702 and the suction side shell 704 to rotate and translate relative to the original nominal position 714 of the trailing edge load-shedding assembly 712 under an external load. As represented in FIG. 7, during deformation of the passive load-shedding trailing edge assembly 712 towards the suction side shell (to shed load) 704, the rotation of the passive load-shedding trailing edge assembly 712 (specifically the pressure side shell 702 and the suction side shell 704) may cause a translation of the suction side shell 704 relative to the pressure side shell 702. The elastomer or composite ribbed type or corrugated type flexible structural elements 722 located at the end-position of the trailing edge may be designed to allow the translation and rotation of the pressure side shell 702 and the suction side shell 704, and may be designed through the choice and layup of the constituent materials to achieve the targeted deformation of the trailing edge.

The mid-positioned flexible structural elements 724, 726 may be configured to perform like a series of stiffness elements or spring elements or damped elements under the external load, allow the trailing edge load-shedding assembly 712 to move from the original nominal position 714 to the deformed position, beyond a predetermined threshold value of the external load, without causing a static or a fatigue damage to the trailing edge load-shedding assembly 712, and allow the trailing edge load-shedding assembly 712 to move back from the deformed position to the original nominal position 714, under the predetermined threshold value of the external load, without causing the static or the fatigue damage to the trailing edge load-shedding assembly 712.

To elaborate further, the ribbed-type or corrugated-type mid-positioned flexible structural elements 724, 726 located at the mid-position of the trailing edge may be bonded to the pressure side shell 702 and the suction side shell 704, at predetermined positions and angles relative to the trailing edge planes in order to achieve a nominal stiffness of the trailing edge assembly 712. At a time when the stiffness is exceeded by the peak acrodynamic load, the flexible trailing edge assembly 712 may begin to deform and subsequently, by using the elastomer or composite ribbed type or corrugated type mid-positioned or end-positioned structural elements that act in a “spring-like” or “damped-like” manner, the flexible trailing edge assembly 712 may return to its nominal configuration 714 as the load decreases.

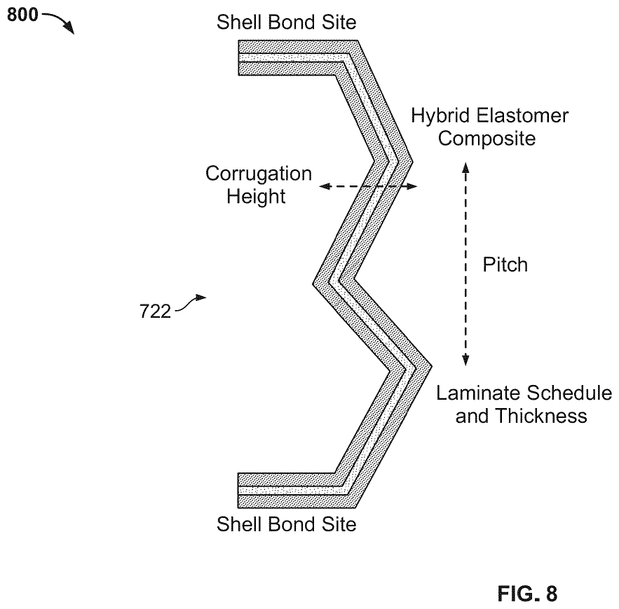

FIG. 8 is an illustrative example of design parameters that may influence the stiffness of ribbed type or corrugated type flexible structural elements, in accordance with an embodiment of this disclosure. In an instance, an analytical model may be developed to determine the stiffness of a rib or corrugation given a set of input parameters. The set of parameters that may influence the stiffness of the ribbed type or corrugated type flexible structural elements may include thickness, type, taper for elastomer composite materials, material weight, type, thickness, taper for glass composite materials, ply drop locations, and geometrical definition parameters such as initial height, bonded height, corrugation definition (number, pitch and height) of the rib and the like.

In operation, prototype webs may be fabricated based on the stiffness models for the ribbed type or corrugated type flexible structural elements and these prototype webs may be subjected to point loads to understand the deflection or stiffness against the model prediction. In an instance, the stiffness models may provide a design for the airfoil with a 20% chord passive load-shedding trailing edge for the 25% lift coefficient reduction, as non-limiting examples.

Unlike traditional designs, the present approach of passively deforming trailing edge construction, as outlined above, enables the development of lower cost wind turbine blades and enables these rotors to enter low wind speed sites which are subject to peak extreme loads. Modern blades commonly utilize carbon fabric or pultrusions in the construction of the spar caps/main laminate. The dimensions (width and thickness) of these structures are directly related to the load environment in which the blade operate. In addition, carbon fiber reinforced laminates are limited by the compressive strength of the material. As such, reductions in loads may lead to direct reduction the material used in the blade.

Specifically, the passive load-shedding trailing edge method and system of the current disclosure include C-web or ribbed or corrugated type flexible structural elements such that the aft 10% to 20% of the airfoil chord deflect may sufficiently to reduce the peak airfoil lift coefficient by 25% (as non-limiting examples) under gust loading that does not require an active articulation of the structure. There may be appropriate hybrid elastomer or composite materials deployed to allow the passive load-shedding trailing edge to recover its nominal shape after deflection and reduction in gust load. Further, a hybrid elastomer or composite material may be selected for construction of the passive load-shedding trailing edge that may survive for several years during the expected operational conditions. The blade design employing the passive load-shedding trailing edge of this disclosure may create the potential for a 7% to 10% increase or 5% to 20% increase in blade length and energy capture, as non-limiting examples, for the same blade weight and loads as a shorter blade.

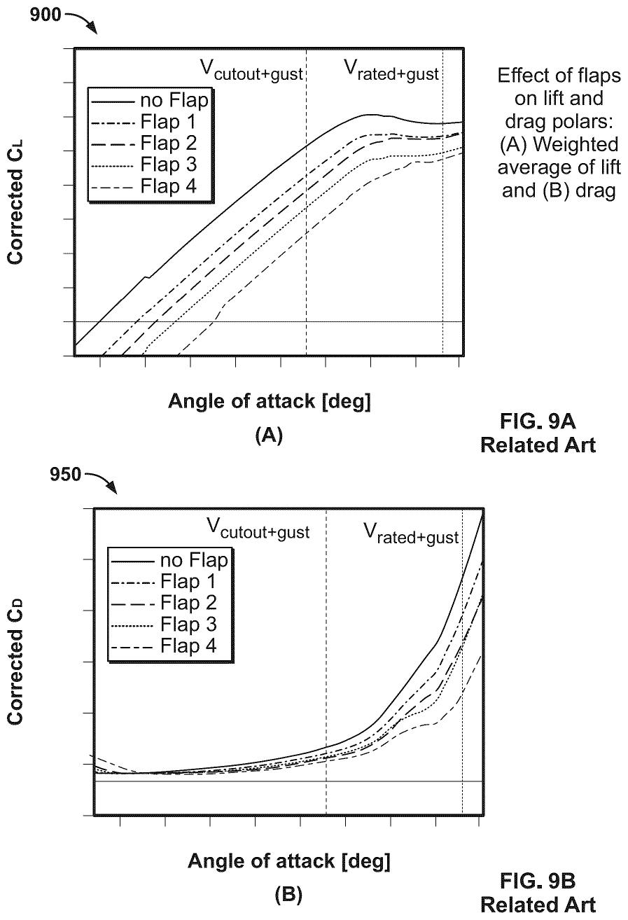

FIG. 9A is an illustrative graphical view 900 of a conceptual aerodynamic model of an airfoil, displaying the effect of flaps on the weighted averages of lift polars, as is known in related art. FIG. 9B is an illustrative graphical view 950 of the conceptual aerodynamic model displaying the effect of flaps on the weighted averages of drag polars, as is known in related art. In an instance, the conceptual acrodynamic models of the airfoil may be used to vary increasing amounts of trailing edge deflection, for a 20%-of-chord passive (as an example) load-shedding trailing edge. The deformation of the trailing edge may be sequentially increased in the analytical model until the peak lift coefficient drops to 75% of its nominal value during gust conditions with deformation of the passive load-shedding trailing edge. The corresponding lift, drag and moment coefficient polars may be derived from the aerodynamic model over a range of angles of attack (−10 to 20 degrees) and gust conditions.

Thus, the example aerodynamic models of FIGS. 9A and 9B may provide pressure distributions for nominal and gust conditions, and airfoil polars (lift, drag, moment) for nominal and gust conditions, for defined angle of attack range, for use in structural deformation loading calculations. A definitive value of the passive load-shedding trailing edge deflection required to achieve an example target of 25% reduction in the peak lift coefficient on the airfoil during a gust condition may be determined.

In an instance, an example aerodynamic model may be used to generate example airfoil parameters required for an acro-elastic simulation of the reference turbine model. Using the defined airfoil polars, an example acro-clastic load simulation of the nominal and passive load-shedding trailing edge may be generated.

Further, in an instance, a frequency of “activation” of the passive load-shedding trailing edge may be determined during the full design loads (as defined by the International Electrotechnical Commission, “IEC”), to determine the fatigue conditions for the passive load-shedding trailing edge during an industry-average 20-year operational life of a turbine. Further, a reduction in peak loads during example simulated gust load conditions (such as extreme wind speed with a fault conditions with the blades failing to pitch and extreme operating gust with grid loss and potentially without grid loss) may be quantified and the time history of the blade root bending moment may be evaluated for the various deformed airfoil conditions. The nominal and passive load-shedding trailing edge blades may be determined and the corresponding expected reduction in loads, as enumerated by design load cases, may be quantified.

In an instance, a thin laminate plate conceptual model may be developed to determine the response and deformation of the four main sub-components (pressure side shell, suction side shell, C-web type flexible structural elements, and ribbed-type or corrugated-type flexible structural elements) of the passive load-shedding trailing edge assembly. These example models of the sub-components may be coupled with the example aerodynamic model mentioned earlier to determine the response of the trailing edge assembly to a nominal and gust load condition. The models may consider the pressure side shell deformation and the suction side shell deformation under a given distributed aerodynamic load (i.e., pressure distribution), the stiffness of a hybrid elastomer/composite stiffness element, for either the C-web type or the ribbed type or corrugated type flexible structural elements.

The specific stiffness response of each of the trailing edge assembly elements may subsequently be developed from an example set of constitutive matrices. The pressure side shell and the suction side shell laminate response may be developed, while the stiffness response of the C-web and ribs may be modeled. Various models of the sub-components may be integrated with materials that may be considered for the hybrid laminate such as ethylene propylene diene monomers (EPDM) or thermoplastic vulcanizates (TPV), and the like, as non-limiting examples. In an instance, Thermoplastic Polyurethane (TPU) material may be considered for the hybrid laminate, as a non-limiting example. These materials may be selected as initial candidates for the hybrid laminate due to their elasticity, weather resistance and potential for recyclability.

Subsequently, the design definition of prototype 20%-of-chord (as an example) passive load-shedding trailing edges may be completed for the airfoil structure, considering both C-web type or ribbed type or corrugated type flexible structural elements. From the resulting design definition, a selection may be made to proceed with either the C-web type or the ribbed type or corrugated type design concept. This design concept may then be prototyped. Using the example design parameters, the various components in the trailing edge design may be fabricated. The components may then be installed into a test fixture by bonding the leading edges of the pressure side shells and suction side shells to a fixed support. The trailing edge assembly may be cantilevered from the fixture. The trailing edge structures may subsequently be subjected to an increasing static load, equivalent to the distributed aerodynamic load, up to a predetermined maximum load. During each application of progressive load, the position of the trailing edge of each panel may be recorded from its nominal position. The position may be recorded with the use of 3D metrology equipment.

In addition to the fabrication and testing, a comparison may be made between the initial coupled aero or structural model results and the measured results. Any differences in the model and experimental results may be documented, with areas of improvement identified. The metric used to determine the completion of this task may be a report documenting the results of the progressive trailing edge loading tests. Areas for model improvement may be identified.

In an instance, using the acroclastic modeling of the reference turbine model, an extension of a wind turbine blade of a desired or target length may be designed and constructed using the passive load-shedding trailing edge airfoil definition. The blade extension may be designed to obtain the same blade root loading and thrust loading as in the initial blade model. The planform of the aerodynamic extension may be modeled and given the extended blade definition and loading, the blade structure may be defined, including the expected contribution of the 20%-of-chord (as an example) passive load-shedding trailing edge for the airfoil. The conceptual model may form the basis for evaluating the potential performance, blade weight, and estimated material costs enabled by the load-shedding design.

The present disclosure relates to systems and methods of constructing passive trailing edge assemblies of FIGS. 5, 6, 7 and 8 with predictable loadshedding capacity under external mechanical forces associated with extreme weather conditions. The systems and methods described herein may be designed to enhance the performance and efficiency of wind turbines and further, to optimize aerodynamic performance and passive load shedding while protecting and reducing structural stress. Specifically, various implementations of the disclosed subject matter relate generally to and may provide improvements in trailing edge assemblies in the way these assemblies respond to extreme weather conditions.

In general, composite structures may utilize a combination of materials, typically fibers and a matrix, to create flexible laminates. The fibers, often made of materials like carbon or glass, provide strength, while the matrix, such as epoxy resin, allows flexibility. In practice, composite materials with varying properties may be employed to achieve the desired flexibility and strength. By carefully arranging and orienting the constituent materials, the composite structures may be enabled to endure repeated movements without compromising their structural integrity. This way, the composite structures are rendered adaptable for applications that require both strength and flexibility such as in trailing edges of wind turbine blades or in similar other mechanical structures.

Composite structures may exhibit elastic behavior up to a characteristic point, where stress is directly proportional to strain. Further, when fiberglass or such other composite structures are subjected to compressive load, they undergo elastic deformation until they reach critical buckling load yield points. Beyond this critical buckling load yield points, the structures become susceptible to buckling associated with a sudden increase in their lateral deflection. When employed in the trailing edge of a wind turbine blade, the composite structure may perform like and have the effect of a passive load controlling and shape restoring mechanism. Further, when the load is withdrawn or ceased the passive load controlling and shape restoring mechanism, i.e., the example composite structures (522 of FIG. 6 or 722 of FIG. 8) may bring a deformed trailing edge back to its original undeformed state.

Thus, the composite structures may utilize a combination of materials, typically composite fibers and a matrix, to create flexible structural elements. The composite materials may be designed to have varying properties to achieve desired flexibility and strength. As an example, the composite fibers may be made of materials such as carbon or glass to provide strength, while the matrix may be made of materials such as epoxy resin to provide flexibility. By carefully arranging and orienting the composite fibers and the matrix, the composite flexible structural elements may be enabled to endure repeated movement without compromising its structural integrity, thereby making it well-suited for applications where both strength and flexibility are essential, such as in trailing edges of wind turbine blades, aircraft wings or such other mechanical structures.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is illustrative and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A wind turbine rotor blade comprising:
a blade body having a shape that generates a lift when impacted by an incident airflow, the blade body comprising a pressure side shell and a suction side shell joining at a leading edge, and a trailing edge; and
a trailing edge load-shedding assembly mechanically coupled with the trailing edge, the trailing edge load-shedding assembly configured to:
move from an original nominal position to a reversibly deformed position under an application of an external load, and
move back from the deformed position to the original nominal position on withdrawal of the external load,
wherein the trailing edge load-shedding assembly comprises:
the pressure side shell,
the suction side shell, and
a plurality of flexible structural elements mechanically coupled with the pressure side shell and the suction side shell, the plurality of flexible structural elements configured to:
cause the trailing edge load-shedding assembly to move from the original nominal position to the deformed position under the external load,
cause the trailing edge load-shedding assembly to move back from the deformed position to the original nominal position on withdrawal of the external load, and
thereby, reduce an overall load on the blade body.

2. The wind turbine rotor blade of claim 1, wherein the flexible structural elements are configured to:
perform like a series of stiffness elements comprising spring elements under the external load,
allow the trailing edge load-shedding assembly to move from the original nominal position to the deformed position, beyond a predetermined threshold value of the external load, without causing a static or a fatigue damage to the trailing edge load-shedding assembly, and
allow the trailing edge load-shedding assembly to move back from the deformed position to the original nominal position, under the predetermined threshold value of the external load, without causing the static or the fatigue damage to the trailing edge load-shedding assembly.

3. The wind turbine rotor blade of claim 2, wherein the plurality of flexible structural elements comprises a first group of end-positioned flexible structural elements and a second group of mid-positioned flexible structural elements.

4. The wind turbine rotor blade of claim 3, wherein the end-positioned flexible structural elements cause the pressure side shell and the suction side shell to rotate and translate relative to the original nominal position of the trailing edge load-shedding assembly under the external load.

5. The wind turbine rotor blade of claim 2, wherein the plurality of flexible structural elements comprises at least one of: C-web type flexible structural elements or ribbed type or corrugated type flexible structural elements.

6. The wind turbine rotor blade of claim 1, wherein the mid-positioned flexible structural elements are configured to:
perform like a series of stiffness elements comprising damped elements under the external load,
allow the trailing edge load-shedding assembly to move from the original nominal position to the deformed position, beyond a predetermined threshold value of the external load, without causing a static or a fatigue damage to the trailing edge load-shedding assembly, and
allow the trailing edge load-shedding assembly to move back from the deformed position to the original nominal position, under the predetermined threshold value of the external load, without causing the static or the fatigue damage to the trailing edge load-shedding assembly.

7. The wind turbine rotor blade of claim 6, wherein the plurality of flexible structural elements comprises a first group of end-positioned flexible structural elements and a second group of mid-positioned flexible structural elements.

8. The wind turbine rotor blade of claim 7, wherein the end-positioned flexible structural elements cause the pressure side shell and the suction side shell to rotate and translate relative to the original nominal position of the trailing edge load-shedding assembly under the external load.

9. The wind turbine rotor blade of claim 6, wherein the plurality of flexible structural elements comprises at least one of: C-web type flexible structural elements or ribbed type or corrugated type flexible structural elements.

10. The wind turbine rotor blade of claim 1, wherein the trailing edge load-shedding assembly comprises a passive trailing edge load-shedding assembly.

11. A wind turbine blade comprising the trailing edge load-shedding assembly of claim 1.

12. A wind turbine comprising one or more turbine blades, the one or more wind turbine blades comprising the trailing edge load-shedding assembly of claim 1.

13. A wind turbine rotor blade comprising:
a blade body having a shape that generates a lift when impacted by an incident airflow, the blade body comprising a pressure side shell and a suction side shell joining at a leading edge, and a trailing edge; and
a trailing edge load-shedding assembly mechanically coupled with the trailing edge, the trailing edge load-shedding assembly configured to:
move from an original nominal position to a reversibly deformed position under an application of an external load, and
move back from the deformed position to the original nominal position on withdrawal of the external load,
wherein the trailing edge load-shedding assembly comprises:
the pressure side shell,
the suction side shell, and
a plurality of flexible structural elements mechanically coupled with the pressure side shell and the suction side shell, the plurality of flexible structural elements configured to:
cause the trailing edge load-shedding assembly to move from the original nominal position to the deformed position under the external load,
cause the trailing edge load-shedding assembly to move back from the deformed position to the original nominal position on withdrawal of the external load, and
thereby, reduce an overall load on the blade body, and
further wherein the flexible structural elements are configured to:
perform like a series of stiffness elements comprising spring elements or damped elements under the external load,
allow the trailing edge load-shedding assembly to move from the original nominal position to the deformed position, beyond a predetermined threshold value of the external load, without causing a static or a fatigue damage to the trailing edge load-shedding assembly, and
allow the trailing edge load-shedding assembly to move back from the deformed position to the original nominal position, under the predetermined threshold value of the external load, without causing the static or the fatigue damage to the trailing edge load-shedding assembly.

14. The wind turbine rotor blade of claim 13, wherein the plurality of flexible structural elements comprises a first group of end-positioned flexible structural elements and a second group of mid-positioned flexible structural elements.

15. The wind turbine rotor blade of claim 14, wherein the end-positioned flexible structural elements cause the pressure side shell and the suction side shell to rotate and translate relative to the original nominal position of the trailing edge load-shedding assembly under the external load.

16. The wind turbine rotor blade of claim 13, wherein the plurality of flexible structural elements comprises at least one of: C-web type flexible structural elements or ribbed type or corrugated type flexible structural elements.

17. The wind turbine rotor blade of claim 13, wherein the trailing edge load-shedding assembly comprises a passive trailing edge load-shedding assembly.

18. A wind turbine blade comprising the trailing edge load-shedding assembly of claim 13.

19. A wind turbine comprising one or more turbine blades, the one or more wind turbine blades comprising the trailing edge load-shedding assembly of claim 13.
